(19) United States
(12) Patent Application Publication
(10) Pub. No.: US 2006/0000132 A1
(43) Pub. Date: Jan. 5, 2006

(54) Serpentine menuboard system

(75) Inventors: Paul Bertheaume, Germantown, WI (US); Paul Steinbrenner, West Bend, WI (US); Mark Hartung, Sussex, WI (US)

Correspondence Address: QUARLES & BRADY LLP, 411 E. WISCONSIN AVENUE, SUITE 2040, MILWAUKEE, WI, 53202-4497, US

(73) Assignee: The Howard Company, Inc.

(21) Appl. No.: 11/170,692

(22) Filed: Jun. 29, 2005

Related U.S. Application Data
(60) Provisional application No. 60/584,285, filed on Jun. 30, 2004.

(51) Int. Cl. G09F 7/22

(52) U.S. Cl. 40/617

(57) ABSTRACT

A menuboard system provides curvable mounting rails formed of laminated elements that may slide with respect to each other to accept a curve and then be tightened together to resist straightening after the curve is set. Display panels may be hung from the mounting rails by angled mounts allowing flexible orientation of the display panels as held by the curved mounting rails.

### CROSS-REFERENCE TO RELATED APPLICATIONS

This application claims the benefit of U.S. Provisional Application 60/584,285 filed Jun. 30, 2004, hereby incorporated by reference.

### STATEMENT REGARDING FEDERALLY SPONSORED RESEARCH OR DEVELOPMENT

--

### BACKGROUND OF THE INVENTION

The present invention relates to menuboards and more particularly to menuboards providing a number of separate display panels above a counter or the like.

Particularly in fast food restaurants, there may be one or more menuboards presenting the restaurant menu and the prices of the menu items offered for sale. Typically these menuboards consist of a number of display panels showing different photographic reproductions of the items offered for sale, together with prices and description. Quite often these menuboards are backlit with the photograph, letters and numbers translucent to emit the light. The backlighting may be contained in a housing behind the display panel which is normally mounted to a wall often specially constructed over the counter.

Conventional menuboards are not easily customized for different restaurants. Menuboards with complex shapes, for example, those which follow a curved counter, must be custom fabricated at great expense. Generally, the menuboards with many display panels are visually massive and may detract from a sense of space and openness desired by some restaurants.

### BRIEF SUMMARY OF THE INVENTION

The present invention provides a menuboard system that may be flexibly adapted to provide a variety of curved configurations. A set of display panels are hung on curvable mounting rails comprised of thin strips of metal or the like separated by a flexible spacer layer, for example, rubber. The mounting rails may be curved on-site to a desired shape; then clamped to retain that curve. The length of the mounting rails may be adjusted by cutting or splicing using portable tools. The curved mounting rails may be hung from the ceiling to present an open framework supporting multiple display panels at different angles.

Specifically then, the present invention provides a menuboard mounting system having at least one mounting rail including a front and rear flexible strip extending along a longitudinal axis on either side of a spacer separating the front and rear flexible strip. Clamps, when clamped, restrain the front and rear flexible strips against relative sliding along the longitudinal axis so that the front and rear strips may be flexed to curve along the longitudinal axis and then set to hold that curve with the clamps. A set of supports attaches to the mounting rail and supports the mounting rail with respect to building structure.

Thus it is one object of at least one embodiment of the invention to provide a curvable mounting rail whose separate elements are flexible to allow simple curvature of the rail for specialized mounting locations without special tools or fixtures. It is another object of at least one embodiment of the invention to provide a mounting rail that, when assembled, provides considerable strength and yet whose separate elements may be trimmed or spliced using simple techniques.

The flexible strips may be flexible only within a plane defined by a lateral and longitudinal axis: for example, by using strips having a transverse height substantially greater than their lateral thickness.

Thus it is another object of at least one embodiment of the invention to provide a flexible mounting rail system multiple parallel rails, when curved, maintain their parallel relationship.

The strips may be metal.

It is thus an object of at least one embodiment of the invention to provide a mounting rail with metallic outer faces for durability, improved surface finish and strength.

The spacer may be a substantially continuous strip of elastomeric material between the front and rear flexible strips.

It is thus another object of at least one embodiment of the invention to provide a visually monolithic rail that is nevertheless light in weight. It is a further object of at least one embodiment of the invention to provide a compliant spacer that allows clamping without gaps around the spacer to prevent slippage of the front and rear flexible strips. It is a further object of at least one embodiment of the invention to provide a mounting rail that provides an intrinsic absorption of applied physical shocks and the like.

The clamps may be bolts passing laterally through holes in the front and rear strips and the spacer, the bolts compressing the front and rear strips about the spacer between a bolt head and a nut.

It is thus another object of at least one embodiment of the invention to provide a simple clamping mechanism that works in conjunction with an elastomeric spacer.

The holes may include longitudinally extending slots.

It is another object of at least one embodiment of the invention to provide a clamping mechanism that may accommodate relative length differences upon curvature of the inner and outer flexible strips and yet which allows fabrication of the holes prior to installation or curvature.

The menuboard may include at least two transversely separated mounting rails held by transverse struts.

It is thus another object of at least one embodiment of the invention to provide an additional dimension of mounting such as may better stabilize and support display panels.

The struts may be releasably attached to the mounting rails with bolts passing through holes in the mounting rails. The menuboard system may include splice elements attaching front or rear strip portions to form greater lengths.

It is thus another object of at least one embodiment of the invention to provide a menuboard system that may be easily shipped and assembled on-site.

The splice elements may be portions of the struts attaching front and rear strip portions with bolts passing through the holes.

It is thus another object of at least one embodiment of the invention to provide an efficient method of making splices without the need for additional elements that may be visually disrupting.

The menuboard system may include an adjuster receiving the supports to adjust a separation of the mounting rail from the building structure. For example, the supports may be threaded rods and the adjuster may be a nut engaging the threaded rod in at least one mounting rail. The threaded rod may have a shroud covering its exposed portion.

It is thus another object of at least one embodiment of the invention to provide a simple method of attaching the mounting rails to the building that accommodates variations in supporting structure and that allows easy leveling of the menuboard system.

The menuboard system may include a series of display panels having mounts attached to the rear surface of the display panels for receiving a mounting rail to support the display panels on the mounting rail.

It is another object of at least one embodiment of the invention to provide a menuboard system that may flexibly accommodate different numbers of display panels.

The mounts may receive two mounting rails separated along a transverse axis and each mount may define a front mounting angle supporting the rear of the display panel and a rear mounting angle attachable to the two mounting rails.

It is thus another object of at least one embodiment of the invention to allow an arbitrary downward canting of the display panels depending on the requirements of the site.

The mounts may include an adjuster allowing a relative difference between the front and rear mounting angle to be adjusted. Further the mount may include a left and right mount having different front and rear mounting angles.

It is thus another object of at least one embodiment of the invention to allow a downward canting of the display panel in conjunction with an arbitrary curvature of the mounting rails.

The display panels may provide edge lit transparent sheets.

It is thus another object of at least one embodiment of the invention to provide visually lightweight display panels that may compliment the lightweight visual quality of the mounting strips.

These particular objects and advantages may apply to only some embodiments falling within the claims and thus do not define the scope of the invention.

### BRIEF DESCRIPTION OF THE DRAWINGS

FIG. 1 is a perspective front elevational view of the menu panel system of the present invention showing curved mounting rails separated by struts as suspended by vertical supports;

FIG. 2 is a fragmentary perspective view of the upper portion of one strut where it attaches to a mounting rail showing laminated construction of the mounting rail and the adjustable connection of the vertical support to the strut;

FIG. 3 is a fragmentary cross sectional view taken along lines 3-3 of FIG. 2 showing the relative sliding of the outer portions of the mounting rail with respect to each other as accommodated by slots when the mounting rail is curved;

FIG. 4 is a perspective front view of the mounting rail of FIG. 1 supporting different types of display panels having different degrees of downward canting as provided by rearward mounts;

FIG. 5 is a side elevational view of one mount of FIG. 4 as assembled to provide for a given downward cant and showing hooks for attaching the mount to the mounting rails of FIG. 4; and

FIG. 6 is an exploded perspective view of the mounting rail of FIG. 5 showing its various elements.

### DETAILED DESCRIPTION OF THE PREFERRED EMBODIMENT

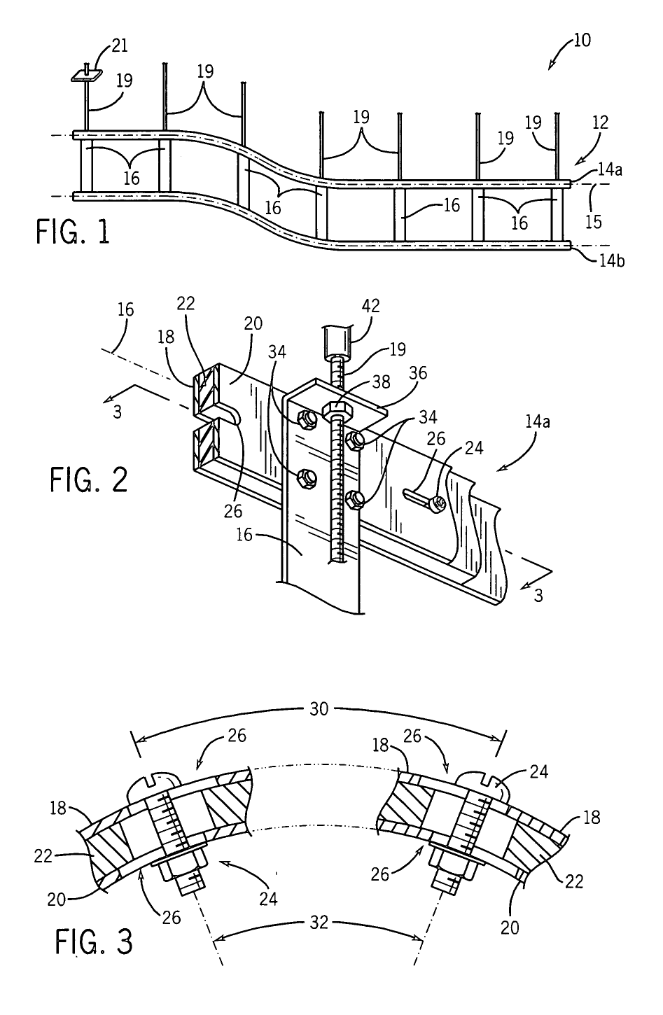

Referring now to FIG. 1, the present invention provides a menu panel system 10 having a curvable support frame 12 comprised, in a preferred embodiment, of two horizontal mounting rails 14a and 14b that may curve gently along a generally longitudinal axis 15.

The mounting rails 14a and 14b are spaced transversely by a series of struts 16 perpendicular to the mounting rails 14a and 14b. The struts 16 attached at their upper end to mounting rail 14a and the lower end at mounting rail 14b.

The support frame 12 is suspended on a series of threaded support rods 19 which, at their lower ends, attach to the upper ends and lower ends of struts 16. The upper ends of the threaded support rods 19 may be received by mounting structure 21 within the ceiling of the restaurant such as tie points attached to ceiling joists or the like.

Referring also to FIG. 2, each of the mounting rails 14a and 14b provide a laterally laminated front flexible strip 18, rear flexible strip 20, and rubber spacer layer 22 of equal transverse height. Generally, the transverse height of each of the front flexible strip 18, rear flexible strip 20, and rubber spacer layer 22 is substantially greater than their lateral thickness so these elements may flex in a lateral direction to curve along the longitudinal axis 15, but generally will not flex transversely.

The laminated elements of flexible strips 18, 20 and rubber spacer layer 22 are retained together by a series of clamping bolts and nuts 24, the bolt shanks passing through longitudinally slotted holes 26 in the front flexible strip 18, rear flexible strip 20, and rubber spacer layer 22.

Initially, the front flexible strip 18 and rear flexible strip 20 may be assembled about the rubber spacer layer 22 with the clamping bolts and nuts 24 holding them loosely together. In this state, the mounting rails 14 may be curved. Referring also to FIG. 3, generally, this curvature will result in the convex side of the curve, in this case the side towards flexible strip 18 having a greater path length 30 along the curve than the path length 32 along the concave side of the curve, in this case the side towards flexible strip 20. This difference in path length is accommodated by the slotted holes 26 in the flexible strips 18, 20 and rubber spacer layer 22 which allows relative sliding between flexible strips 18, 20, and rubber spacer layer 22.

When the clamping bolts and nuts 24 are tightened, the friction developed between the flexible strips 18, 20 and rubber spacer layer 22, caused by the compression of flexible strips 18 and 20 against the elastic surface of the rubber spacer layer 22, prevents relative sliding between the flexible strips 18, 20 and rubber spacer layer 22 and thus holds the curvature in place. It will be understood that the laminations of the mounting rails 14a and 14b provide an effective truss structure whose height also resists torsion along the longitudinal axis 15 and which offers good support for display panels to be hung on the mounting rails 14a and 14b as will be described.

Preferably, the flexible strips 18 and 20 are steel, however, other materials such as fiberglass composites may also be used provided they exhibit the necessary compression and tension strength necessary to hold a curve when assembled in the mounting rails 14. The outer flexible strips 18 and 20 may be provided with attractive surface finishes suitable for metal or other materials as will be understood in the art.

The resilience of rubber spacer layer 22 provides for a locking effect on the clamping bolts and nuts 24 by providing a lock washer-type outward force. The elasticity of rubber spacer layer 22 also provides a dampening effect on the laminated mounting rails 14 resisting shock, deadening acoustic noise transmission, and accommodating differences in expansion rates of the materials. It will be understood that other materials for the spacer layer may be used and that a continuous spacer layer, while desirable, is not required so long as a clamping can be obtained to prevent relative shifting of the front and rear flexible strips 18 and 20 about the spacer layer.

Fasteners 34 passing through slotted holes in the upper and lower ends of the strut 16 may attach the struts 16 to the flexible strips 18 and 20 at regular intervals. In this way, the struts 16 may be attached to the rails 14a and 14b on-site to provide a compact shipment volume.

The individual flexible strips 18, 20, and rubber spacer layer 22 may be easily cut to shorter lengths with simple portable tools on-site or before shipping. Alternatively, longer mounting rails 14a and 14b may be created using splice plates overlapping longitudinal ends of two portions of flexible strips 18 and 20 and joined to the flexible strips 18 and 20 with fasteners on each side of the seam. Referring again to FIG. 2, the splice plate may be provided by the upper end of the strut 16 with a splice seam positioned beneath the strut 16, so that the strut 16 bridges seam and fasteners 34 hold the ends of the flexible strips 18 and 20 to the overlapping strut 16.

At the top and bottom of strut 16, typically positioned to the rear of the support frame 12, are lateral flanges 36 extending rearward from the strut 16. The inner opposed surfaces of the flanges 36 may have a welded nut 38 aligned with a central hole 40 that may receive the vertical threaded support rods 19. Rotation of the threaded support rods 19 thus allows adjustment of the height of the support frame 12 with respect to the mounting structure 21. The lower end of the strut 16 (not shown in FIG. 2) is generally a mirror image of the upper end of the strut 16.

The tensile and compressive resistance of the vertical threaded support rods 19, unlike a chain. for example, together with the curvature of the mounting rails 14 limits bending of the vertical threaded support rods 19 by converting torque along longitudinal axis applied to the mounting rails 14 to compression and tension of the multiple unaligned vertical threaded support rods 19. In addition, the two points of connection between the support frame 12 and the stiffness of the threaded support rods 19 resists tipping of the support frame 12 under offset loads

A decorative shroud 42 may be placed around the threaded support rods 19 between the support frame 12 and the mounting structure 21 if desired.

Generally, during installation, once curvature of the support structure is established and clamping bolts and nuts 24 tightened, the support frame 12 may be positioned beneath the ceiling and appropriate marks made on the ceiling, for example, using a plumb bob or the like made to locate the necessary mounting points.

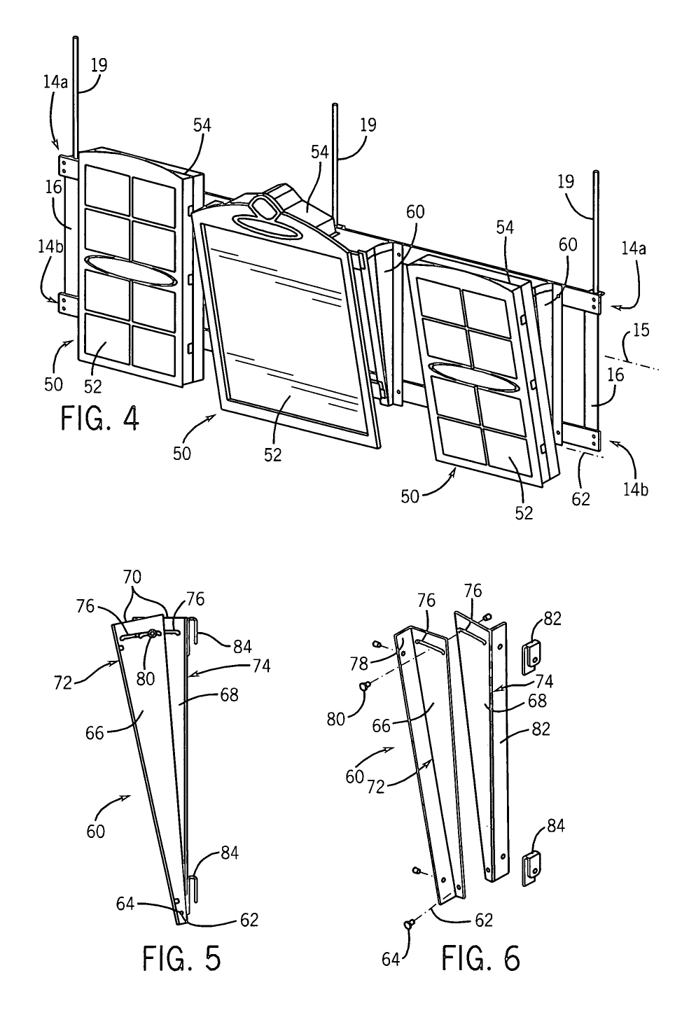

Referring now to FIG. 4, a number of display panels 50 may be attached to the front of the support frame 12 to display menu items to customers. Each of the display panels 50 may include a display surface 52, for example, supporting a film or other translucent or transparent elements depicting pictures or text and numbers related to the menu items. The display surface 52 may be the front of a light box 54, for example, of a type as generally described in U.S. Pat. No. 5,379,540, entitled Modular Sign System, assigned to the assignees of the present invention and hereby incorporated by reference. The light box 54 may include a number of lamps so as to backlight the display surface 52. Electrical connections to the light boxes 54 may be made by cables (not shown) passing along the rear of the rails 14a or 14b. Alternatively, edge lit display panels may be used as described in co-pending U.S. application entitled: Thin Profile Light Board, assigned to the same assignee as the present invention and hereby incorporated by reference. In this way, a visually lighter design may be created using the open support frame 12 with thin, edge lit display panels having relatively low visual mass.

Referring now to FIGS. 4, 5 and 6, the display panels 50 may be mounted to the rails 14a and 14b by means of angulation mounts 60 attached to the left and right edge of the rear of the light boxes 54. The angulation mounts 60 allow a canting of the display surface 52 about the longitudinal axis 15 so that the display surface 52 may be more easily viewed by customers of the restaurant.

Each angulation mount 60 provides generally a pivot point along pivot axis 62 positioned near the lower rail 14b. The pivot point is provided by a pivot pin 64 joining the apex of two triangular adjustment plates 66 and 68 having bases 70 positioned near the upper rail 41a. The bases 70 overlap and may slide from a fully overlapped configuration to a partial overlap to expand like a fan and thus to change an angle between a front edge 72 of plate 66 and a rear edge 74 of plate 68. The area of overlap of each of the bases 70 includes aligned slots 76 through which a fastener 80 may be inserted to hold the plates 66 and 67 locked with a particular angle between edges 72 and 74 as desired by the user.

The front edge 72 of plate 66 includes a perpendicularly extending flange 78 that may be attached to a rear planar surface of a display panel 50 to define the angle of that display panels 50 with respect to the vertical orientation of edge 74 that may abut the rails 14a and 14b.

Plate 68 also includes a perpendicular flange 82 at edge 72 extending in the opposite direction of flange 78 and providing a mounting surface to which clips 84 may be attached. The clips 84 have downwardly extending tabs that may fit over the tops of the edges of the mounting rails 14 to allow mounting thereon.

Generally, the curvature of the rails 14a and 14b may require different angle settings of the angulation mounts 60 for a particular desired orientation of the display surfaces 52 of the light boxes 54.

It is specifically intended that the present invention not be limited to the embodiments and illustrations contained herein, but include modified forms of those embodiments including portions of the embodiments and combinations of elements of different embodiments as come within the scope of the following claims.

We claim:

1. A menuboard mounting system comprising:
(a) at least one mounting rail including:
(i) a front and rear flexible strip extending along a longitudinal axis;
(ii) a spacer separating the front and rear flexible strip along a lateral axis perpendicular to the longitudinal axis;
(iii) clamps restraining the front and rear flexible strips against relative sliding along the longitudinal axis when clamped; whereby the front and rear strips may be flexed to curve along the longitudinal axis and then set to hold that curve with the clamps; and
(b) a plurality of supports attaching at one end to the mounting rail to support the mounting rail with respect to a building structure.

2. The menuboard system of claim 1 wherein the flexible strips are substantially flexible only by curving in a plane of the lateral and longitudinal axes.

3. The menuboard system of claim 2 wherein the flexible strips are thin plates having a transverse height substantially greater than a lateral thickness.

4. The menuboard system of claim 1 wherein the strips are metal.

5. The menuboard system of claim 1 wherein the spacer is a substantially continuous strip of elastomeric material between the front and rear flexible strips.

6. The menuboard system of claim 1 wherein the clamps are bolts passing laterally through holes in the front and rear strips and the spacer, the bolts compressing the front and rear strips about the spacer between a bolt head and a nut.

7. The menuboard system of claim 6 wherein the holes include longitudinally extending slots.

8. The menuboard system of claim 1 including at least two transversely separated mounting rails held by transverse struts.

9. The menuboard system of claim 8 wherein the struts are releasably attached to the mounting rails with bolts passing though holes in the mounting rails.

10. The menuboard system of claim 1 further including a splice element attaching a first front or rear strip portion to a second front or rear strip portion to form a substantially continuous front or rear strip of greater longitudinal length than the portions.

11. The menuboard system of claim 10 including at least two transversely separated mounting rails held by transverse struts and wherein the splice elements are portions of the struts attached to the front or rear strip portions with bolts passing through holes.

12. The menuboard system of claim 1 including an adjuster receiving the supports to adjust a separation of the mounting rail from the building structure.

13. The menuboard system of claim 12 wherein support is a threaded rod and the adjuster is a nut engaging the threaded rod and at least one mounting rail.

14. The menuboard system of claim 13 further including a shroud covering an exposed portion of the threaded rod.

15. The menuboard system of claim 1 further including a series of display panels having mounts attached to a rear surface of the display panels for receiving a mounting rail to support the display panels on the mounting rail.

16. The menuboard system of claim 15 wherein the mounts receive at least two mounting rails separated along a transverse axis.

17. The menuboard system of claim 16 wherein each mount defines a front mounting angle supporting the rear of the display panel and a rear mounting angle attachable to the two mounting rails, the front mounting angle being different from the rear mounting angle.

18. The menuboard system of claim 17 wherein the mount includes an adjuster allowing a relative difference between the front and rear mounting angle to be adjusted.

19. The menuboard system of claim 18 wherein the mount includes a left and right mount having different front and rear mounting angles.

20. The menuboard system of claim 19 wherein the mount has a front and rear element pivoting with respect to each other about an axis near a lower mounting rail and providing a fixable separation between ends near an upper mounting rail.

21. The menuboard system of claim 15 wherein the display panels include edge lit transparent sheets.

22. A method of fabricating a menuboard mounting system having at least one mounting rail with a front and rear flexible strip extending along a longitudinal axis and a spacer separating the front and rear flexible strip along a lateral axis perpendicular to the longitudinal axis; and clamps restraining the front and rear flexible strips against relative sliding along the longitudinal axis when clamped, the method comprising the steps of:
(a) curving the mounting rail along the longitudinal axis by sliding the front flexible strip about the spacer with respect to the rear flexible strip;
(b) clamping the front and rear flexible strips to hold a curve of step (a); and
(c) attaching the curved mounting rail via supports to building structure.

23. The method of claim 22 including the step of cutting at least one of the front and rear flexible strips to provide a necessary length.

24. The method of claim 22 including the step of splicing at least one of the front and rear flexible strips to provide a necessary length.
